(19) United States
(12) Patent Application Publication
(10) Pub. No.: US 2011/0181534 A1
(43) Pub. Date: Jul. 28, 2011

(54) System for remotely controlling computerized systems

(76) Inventor: Angel Palacios, Madrid (ES)

(21) Appl. No.: 12/963,507

(22) Filed: Dec. 8, 2010

(30) Foreign Application Priority Data
Dec. 1, 2009 (ES) P200902264

(51) Int. Cl. G06F 3/041

(52) U.S. Cl. 345/173

(57) ABSTRACT

The present invention facilitates the remote utilization of computerized systems, such as for example a computer that is connected to a television. This is the case, for example, of computers that are connected to a television in the living room. In this case, the current remote control units have several problems for text entering, mainly that the user needs to change her sight from close to far to close again. The invention is based on two aspects. On the one hand, showing a keyboard on the screen, and on the other hand using a remote control that comprises a touch surface which allows to show on the screen the position of the user's fingers. In so doing, the user can utilize the remote control simple looking at the television, because at all times she Hill be able to see where the fingers are located and on what key they are positioned.

### INDUSTRIAL FIELD

The current invention belongs to the field of consumer electronics, more precisely to the field of consumer informatics.

### PRIOR ART

It often happens that in living rooms there are one or more video systems, such as television sets and video recorder-players, in any of the possible orientations, such as VHS, DVD, Blu-Ray and so no.

These systems are usually associated to a remote control that allows to access the system's functions without having to be close to the equipment.

Nowadays, one of the aspects that is not well solved in this field is text entry. Entering text is necessary in diverse situations, such as when a TV program has been recorded and the user wishes to enter its title.

In general, entering text in the current equipments is usually approached in two different ways. In the first way, depicted in FIG. 1, the remote control has four control button for directions left 101, right 102, up 103, down 104 and a control button for ‘ok’ 105. Besides that, the system shows a keyboard on the TV screen and a cursor 201 on it, as shown in FIG. 2. Controls 101-104 are used by the user to move the cursor 201 over the keyboard.

The user employs the directional buttons 101/104 to move the cursor and go through the keys (or numbers) of the keyboard that is shown on the screen. When the cursor is on the chosen key, the user can press the button “ok” 105 in the remote control to select it.

In the second way, the remote control contains a keyboard, such as the one shown in FIG. 3. If the user presses a key, the key is transmitted to the screen. In general the keyboard is a “summary keyboard” (similar to those that exist in most mobile telephones), in which each button corresponds to three or four different keys. When the user presses a button several times within a short time interval between presses, the system changes the letter that is assigned to that button. When the time lapsed is longer than a certain threshold, the system interprets that the last key that was sent is the one selected, and it chooses it. In these cases, the system is strengthen by a predictive text application that avoids having to press several times the same button to choose a letter.

The appearance of new informatics and electronic systems in general has created new utilization situations, and entering text in an agile way has become an important need. For example, in mobile telephony, until recently, most telephones used summary keyboards. However, recently, the utilization of electronic mail in the mobile has create the need for more complete keyboards. The result is that currently there exist many phones that contain keys for most of the necessary characters. The most typical format are QWERTY keyboards, such as for example the device in FIG. 4b.

In the case of video systems in particular, new systems have appeared in the household, such as game consoles, “media centers” and general purpose computers that are connected to the TV. In all these cases new types of remote controls have been developed.

For game consoles, they are remote controls specifically adapted for the type of game, including joystic-levers and steering wheels. In the case of media centers, they are devices which are similar to the traditional remote controls for video and television.

In the case of general purpose computers that are connected to televisions, some devices have been developed which are similar to the mouses and keyboards that are usually employed with computers, that which are adapted to a different context.

For controlling the movement of the cursor, there mainly exist these devices:

1. Wireless mouses that comprise a “trackball”. The trackball allows to move the cursor on the screen without having to move the mouse over a surface. An example of these devices is Trust's “Wireless Laser Presenter Mouse”(http://www.trust.com/products/product/aspx?artnr=16449)
2. Aereal mouses. In these devices, a control system detects the position of the mouse by using gyroscopes, accelerometers and/or compasses. The position of the mouse is applied to the position of the cursor, so mat the user can move the cursor just by moving the hand that is holding the mouse. An example of these mouses is Logitech's “MX Air™ Rechargeable Cordless Air Mouse” (http://www.logitech.com/index.cfm/mice pointers/mice/devices/3443&cl=US,En)
3. Other example is the “Air Mouse iPhone”, a software program that turns an iPhone or iPod in an aereal mouse (http://www.mobileairmouse.com/) The “Air Mouse iPhone” also implements a “trackpad”, i.e., a touch surface that detects the position of a finger and moves the cursor over the screen.

For entering text, the main products are wireless keyboards that also contain a “trackball” or “trackpad” to replace moving the mouse, and in which the utilization of the buttons of the mouse has been modified in order to take into account the fact that it is likely that the user is not sitting at a desk. The devices are similar to these ones:

1. Trust's “Wireless Entertainment Keyboard” (http://www.trust.xom/products/product.aspx?artnr=14909). This is a standard keyboard that comprises a “trackball” to move the cursor. It also comprises mouse buttons that are placed on both upper comers, just in the place where the user's fingers will be placed when the user is holding the keyboard with his/her hands.
2. Logitech has designed the model “diNovo rami”. (http://www.logitech.com/index.cfm/keyboards/keyboard/devices/3848&cl=ES,ES) This is a keyboard similar to the previous one, but with small size. Instead of a “trackball” it contains a “trackpad” to move the mouse cursor.
3. The “Air Mouse iPhone” previously described. This program for iPhone and iPod Touch shows the classic iPhone keyboard on the screen of the device. As the user enters text, the text is shown on the computer screen to which it is linked, and the last characters that were entered are also shown on the screen of the iPhone or iPod.

In all these new devices, text entering presents important problems.

1. Normal size keyboards (such as Trust's “Wireless Entertainment Keyboard”, previously described) have these problems.

They have a larger size man the devices that are normally used with televisions and videos, which makes them less easy to handle with.

They do not allow to fully use all the advantages of normal keyboards, because they are not going to be used on a flat and stable surface, such as a desk. This makes it difficult to type with the same easy as in a desk.

2. Small keyboards, such as Logitech's model

These keyboards require that the user is continuously switching the sight between the device and the TV screen.

Switching the sight in small distances, such as between the keyboard and the screen of a mobile device, or between a keyboard and a nearby computer screen, does not generate problems. However, switching the sight between a close position (when searching for a key in the keyboard that is being held in the hand) and a far position (when checking on the TV the text that was entered) does generate a lot of uncomfortable sensation.

Normal size keyboards do not generate this problem for those users that can type fluently, because in general these can only watch at the television, and to not have to be watching the keyboard, searching for the keys. However, because the keyboard if often laid on the lap, instead of over a desk, typing is more uncomfortable, and it often happens that the users also have to be checking both the screen and the keyboard.

This is not possible however with small keyboards, because it is very doubtful that there exist people that type on them with the same agility as in normal size keyboards.

3. Touch screen keyboards, such as the “Air Mouse” present these problems:

The need to keep switching the sight between the device and the television. This need is smaller than in the case of keyboards such as diNovo, because the device screen can

show the last characters of the text that is being typed.

However, due to the fact that it is a small device, if the user wants to type a text of some length, the user needs to look at the TV.

As in the case of keyboards such as diNovo, it is necessary to look at the device, because it is doubtful that someone will be able to type in an iPhone or similar device without looking at the keyboard.

In summary, the problems of current devices for text entering are mainly one of the following:
1. The have large size, which makes them difficult to handle
2. The require alternating the sight between near (device) and far (television), which is uncomfortable and even harmful for the eyes eight.

### Explanation of the Invention

The invention seeks to solve the previous problems. In the most basic aspect, ft is based on:
1. Using a touch surface, which can be opaque and therefore cheaper than a touch screen.
2. Optionally can be created on a hand device, of small size, similar to the size of a remote control.
3. And specially, using a system to manager characters that relieves the need to alternating the sight between near an far.
The previous elements are structured as explained below:

1. Using a device that contains a touch screen that will work in a similar way to how a “touchpad” words. The user will move a point of contact over the surface, which in turn will move a cursor over the screen of a computerized system that the user wants to control, as will be explained later. Moving the point of contact can be done, for example, moving a finger over the surface or sliding another object that is in contact, such as a pointer stick. In order to facilitate the exposition, in this document it will be assumed mat the user is using the finger.

2. Showing a finger on the screen of a computerized system that the user wants to control. In this description, in order to facilitate the exposition, it will be assumed that it is a TV screen, but it could be a computer screen.
3. Divide the touch surface in areas that correspond do keys. That is to say, associating each area in the surface with a key, in correspondence with the keyboard that is shown in the previously mentioned screen.
4. Place a cursor on the screen, whose position will depend on the position of the finger that is moving over the touch screen.

It is important to indicate that the cursors can be moved over the screen keyboard following “continuous movement” or “discrete movement”. In the first case, the cursor moves a certain distance over each key, following the movement of the finger over the surface. In the first case, the cursor moves a certain distance over each key following the movement of the finger over the surface when this one moves a certain distance. In the second case, the cursor remains static on a key while the finger does not change its position beyond a certain distance. Then, it suddenly moves and now will be placed over a different key when the finger has moved sufficiently and now is over said key.

This aspect is also a matter of design. In order to facilitate the exposition of the invention, in this document it is assumed that the cursor moves in the discrete fashion, i.e., it remains fixed over a key as long as the position of the finger is within a certain range around that key.

5. Using absolute positioning for placing the cursor on the screen with respect to the position of the finger over the tactile surface. This way to position the cursor is different to the way that is usually employed in “toucbpads” or in mouses, and is key in this invention. Due to its importance and despite the fact that there exist main devices with touch surfaces that implement absolute positioning, it will be explained in more detail in the section, where an embodiment of the invention is explained.

It is important not to confuse positioning with movement, despite both concepts refer to the cursor's location. Movement is related to how the location of the cursor is modified with the location of the finger is modified. Positioning is related to where to place the cursor when the user raises the finger and places it on a different area over the touch surface.

6. Detecting whether the user has performed an action to choose a key on the touch surface. The user has performed the action, the system will assume that the user has chosen the key on which the screen cursor was located at that point, which will have to correspond with the key that has been assigned to the area of the surface on which the finger is positioned.

There exist several ways to produce and detect the act of choosing a key, or the act of choosing a concrete point, on a touch surface. One of them is pressing with the finger more strongly on the surface, so that the system detects an increase in the area that is in contact. Other way is raising the finger over the chosen key, or performing a touch during a brief interval of time, or performing a double touch. The ways to select a point are already known to the expert in the field, and therefore they will not be described here.

A key aspect in the invention is that the user will be using the keyboard in the device, but in order to position his/her finger over said keyboard, he/she will be receiving feedback information from the screen, via the position of the cursor that is shown on said screen. The position of the cursor will follow the position of the finger over the touch screen. This will allow the user to estimate the relation that exists in each moment between the position of the finger and the keys of the keyboard.

Besides that, when the user performs an action to press a key, he/she will see the pressed key on the screen, which will provide more information about the position of the finger.

At each moment, when the user wants to press a key, he/she will observe the position of the target key and will be able to compare its position with the position of the current key. Then, the user will employ that information to move the finger to the target key.

In the case in which the user makes a mistake and presses a key that he/she did not wanted to press, he/she will see that the cursor is not on the desired place. Then, he/she will go to the delete key, and press again the key that he/she really wanted to press.

It must be noted that the invention is useful not only for sending text to the computerized system, but to send all types of commands, such as for example “play video”, “eject video” etc. The actual choice of the commands that will be implemented is a matter of design.

Advantages and Inventive Nature of the Invention

The main advantage of the invention is that it allows to type in a computerized system without having to switch the sight between said system and the device that is being held in the hands. Switching the sight is uncomfortable, because it requires to adjust the focus of the eyes between close and mid distance.

The system provides, from the screen, a large amount of information for the user to place the fingers on the appropriate areas on the touch surface. The representation of the cursor on the screen will allow him/her to move both fingers with precision, without having to switch the sight between the device and the screen.

The fact that the user can receive information from the screen regarding where the fingers are positioned can be confusing at first, but it is known that the brain is able to integrate this type of information. In fact, the brain performs something similar to what it does when is guiding the fingers of a typist over a keyboard, or when, a surgeon uses a screen to guide the movement of surgical equipment

Despite the distance between the keys of the keyboard that appears on the screen is different to the distance between the keys on the device, observing the distance between the keys on the screen will allow the user to move his/her ringer to reach the wished key in the device that is holding in the hand. There are many evidences about neuronal plasticity that indicate that the brain is able to use that information regardless that difference in distance. The book “The Brain That Changes Itself”, by Normal Doidge, (James H. Silberman Books, 2007) presents numerous evidences of that sort, and also does “Phantoms in the Brain” by Sandra Blakeslee and VS Ramachandran (Forth State, 1998).

In particular, Blakeslee and Ramachandran explain a perceptual illusion that is based on an association that the brain does between a series of random presses that the person is receiving on the skin, with a pulsing movement that the person might see in a different place. In the experiment that is performed to text that illusion, a person acting as the subject of the experiment receives on the skin a series of presses which are performed by a second person, and simultaneously, the subject is seeing how the second person is performing the same presses with the other hand on other object. The subject will perceive the sensation that the second object is part of his/her corporal structure.

An important difference with other existing systems is that the invention combines two keyboards: the keyboard shown on the screen and the keyboard created over the device. As far as is known, the system that are known to introduce text only contain either the keyboard on the device that the user is employing or the keyboard that is shown on the screen. But using two keyboards, which at first sight might look redundant, provides benefits for the user.

Another important difference is using a touch surface and showing on the screen the movements of the user's finger, which provides even more information to allow the utilization of the keyboard with more control.

In the explanation of an embodiment other elements of the invention are explained that also provide important advantages, and that have not been seen in other systems. For example, adding uneven areas (i.e. protuberances, bumps, bulges) to the touch screen, and showing the position of several fingers on the screen.

### DESCRIPTION OF THE DRAWINGS

FIG. shows a control that is usually present in remote controls to send commands to video systems and televisions.

FIG. 2 shows a keyboard that can appear on the screen of a television.

FIG. 3 shows a summary keyboard, typical in mobile phones.

FIG. 4a schematically shows the combination of a screen and a touchpad for controlling the entering of characters by a user.

FIG. 4b shows a keyboard that has been created over a touch surface.

FIGS. 5a, 5b and 5c schematically show the system of relative positioning.

FIG. 6 shows, with the aid of Figures 5b and 5c, the system of absolute positioning.

FIG. 7 shows the combination of the touch surface to choose keys and the keyboard that is shown on the screen that is intended to be controlled.

FIG. 8 shows a block diagram of the elements that the device 700 is composed of

FIG. 9 schematically shows the possibility to add a certain uneven areas or bulges to the graphical keys in keyboard 701, so that the uneven areas assist the user to position bis/her fingers over the keyboard.

FIG. 10 shows another type of element to create an uneven area or a bulge on the graphical keys in keyboard 701.

FIG. 11 shows a summary keyboard.

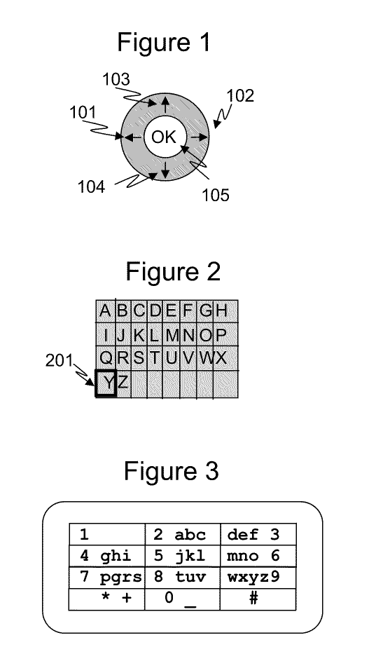

### EXPOSITION OF AN EMBODIMENT OF THE INVENTION

### DESCRIPTION OF THE PREFERRED EMBODIMENT

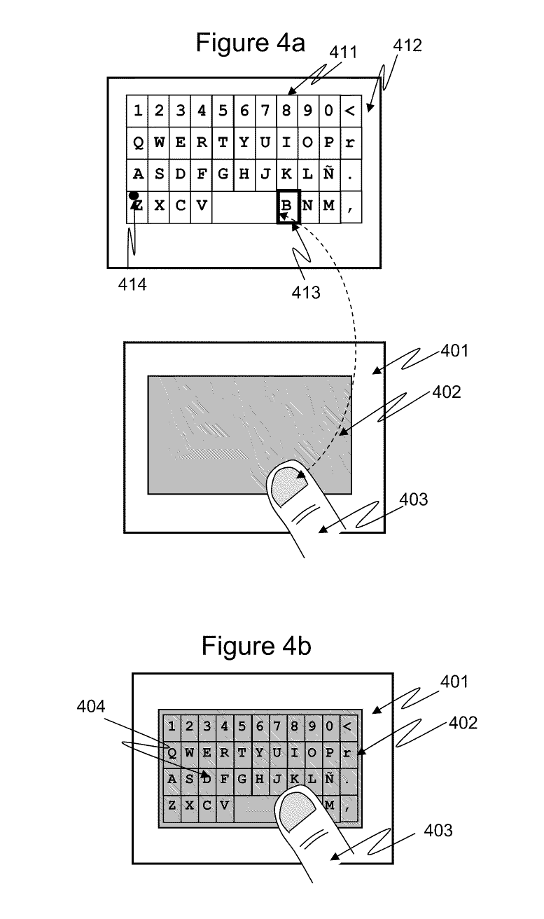

In what follows, in order to facilitate the comprehension of the invention, a general description of the invention is offered based on the figures. Later on, the preferred embodiment will be described in detail.
1. The device 401 (shown in FIG. 4a) comprises a touch surface 402, which works in a similar way to a touchpad. The user can slide a point on contact on the surface, which in turn moves a cursor on the screen 412 as will be explained later.
2. The Figure also shows keyboard 411 over the screen 412 of a computerized system that the user wants to control, and which in the preferred embodiment will be a television. The screen 412 has been represented in small size in relation to the keyboard 411 to facilitate the creation of the Figure.

The distribution of the characters in that keyboard is a matter of design, and FIG. 4 and the other Figures only show distributions with an example intention. Other characters might have been chosen, or they might have been place with a different distribution. Also, additional character might have been selected and they might have been place sharing those same keys with the characters that are already shown, so that depending on a selector one or other character set might become active. The question of what characters are chosen and how they are to be distributed in a matter of design, and it will not be described in detail in this section. This topic is postponed for the detailed description of the preferred embodiment.

3. Surface 402 is divided in areas that correspond to keys, as shown in Figure 4b. In the Figure appears a keyboard, but it would not be necessary to draw said keyboard over the touch surface, but simply associate each area of the surface with a key, in correspondence with keyboard 411.
4. Positioning a cursor 413 over the screen 412 of the television, whose position will depend on the position of finger 403. It must be indicated that the cursor could have been represented in other different ways, such as for example as a black circle 414, or as a small cross. With the purpose of facilitating the exposition of the invention and without loss of generality, it has been chosen to show a cursor by an emphasis with a black square 413 over the key on which the cursor is.

As was indicated previously, the cursor 413 could move in a continuous fashion or in a discrete fashion. This aspect is also a matter of design. With the purpose of facilitating the exposition of the invention, in this document it is assumed that the cursor 413 is fixed on a key as long as the finger is within a certain range around said key.

5. The cursor 413 will be positioned in absolute manner depending on the position of the finger 403 on the surface 402. This manner of positioning the cursor is different to the usual manner that is usually employed in “touchpads” or in the managing mouses, and is key in the invention.
6. Detecting whether the user has performed an action of choosing a key on the touch screen. In case the user has performed such an action, the system will assume that the user has chosen the key in the keyboard 411 on which the cursor 413 was at that moment. In the case depicted in FIG. 4, the cursor 413 is positioned on letter B.

As was mentioned previously, the following paragraphs will analyze in more detail the matter of how to establish the position of cursor 413 in relation to the contact position of finger 403 (or of other object that might be used, as explained before).

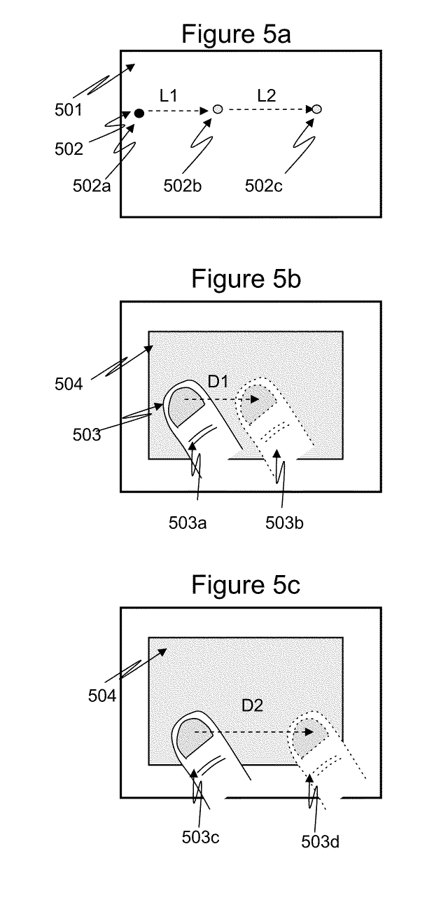

The usual way of positioning a cursor in informatics systems is “relative positioning”, and is shown in Figures 5a, 5b and 5c. The figures depict a screen 501 in which there exist a cursor 502, which has been represented in three different positions. 502a, 502b and 502c.

The position of cursor 502 is controlled by the positions that the finger 503 can take over the touch screen 504, which are represented in Figures 5b and 5c. The finger 503 is represented in four positions 503a, 503b, 503c and 504d.

At one point, the finger 503 is in position 503a, and the cursor 502 is in position 502a.

After that, the finger 503 moves a distance D1 keeping contact with the surface, from position 503a to position 503b. It can be observed that the cursor 502 moves a distance L1 equivalent from the position 502a to position 502b. This movement in contact with the surface does not strictly require a physical con tact but it requires only that the touch surface detects the position of the finger. Depending on how the touch surface is designed, this distance can be higher or lower.

In the next step the finger 503 moves away from the surface 504 and gets back again positioning in position 503c. During this movement there has been no contact with the surface 504 (the surface has not detected the change in the finger's position) and therefore the cursor 502 remains in position 502b.

In the next step, finger 503 moves, keeping the contact with the surface 504, a distance D2 up to the position 503d. Because in this case contact has been kept, cursor 502 moves a distance L2 from position 502b to position 502c.

As was observed, in the finger's movements, the relevant information is not the absolute position of the finger, but only the movement, i.e. its relative position in two different moments in time. Relative movement is the usual way to place cursors using touchpads and also using mouses.

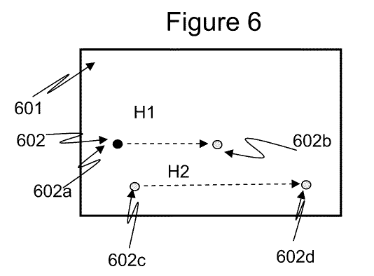

As was mentioned, in the invention the cursor will be positioned in absolute manner, as is depicted in FIG. 6 in relation to the finger movements represented in Figures 5b and 5c. In FIG. 6 a screen 601 is shown in which the cursor is being positioned in absolute manner. It can be seen that the cursor 602 appears placed in four different positions: 602a, 602b, 602c and 602d.

If the finger 503 takes position 503a, the cursor 602 will take obligatorily the equivalent position 602a. If now the finger moves to position 503b, the cursor 602 will move to the equivalent position 602b, which is the screen position that corresponds to the position 503b of the finger. The cursor will end in position 602b independently of whether or not the finger 503 has moved keeping contact with the touch surface.

If the finger now takes position 503c, the cursor will take the corresponding position 602c, and if the finger changes to position 503d, the cursor will change to position 602d.

It can be observed that the cursor 602 is always in positions that correspond in a fixed way to the position of finger 503.

As was indicated earlier, there exist the option to move the cursor in a discrete way, which was used in FIG. 4. In this movement manner, the cursor would appear positioned on the same key, despite the finger might make small movements around a certain range. Discrete movement is compatible with absolute positioning. Choosing continuous or discrete movement is a design option and a topic that is considered sufficiently well known for the expert in the field.

As was mentioned earlier, a key aspect of the invention is the way in which the user receives information about the position in which his/her fingers are. The user will be using the keyboard 402/404 in device 401, but in order to place the finger on the keyboard will be receiving feedback information from the screen 412, via the position of the cursor that the user has pressed.

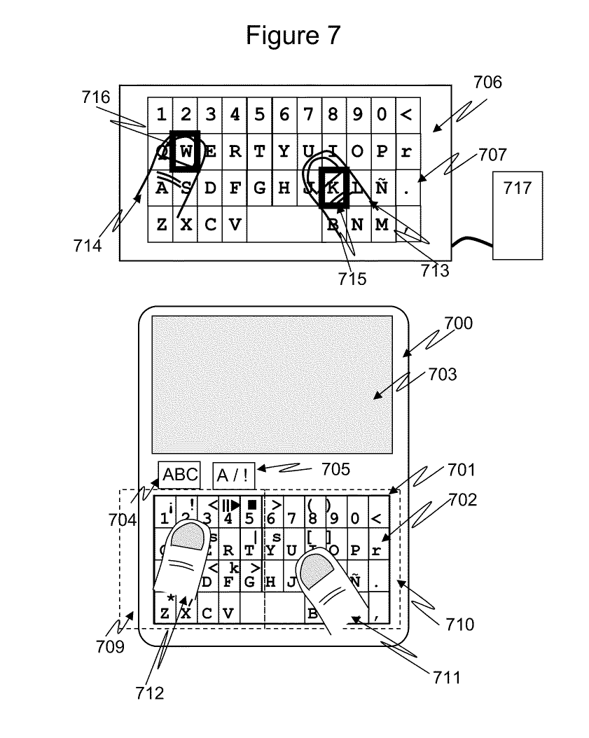

On the previous basis, the preferred embodiment comprises in particular the following elements that are schematically shown in FIG. 7:

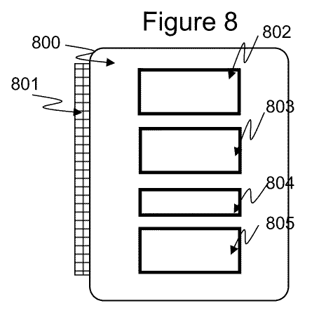

1. A device 700 that has a similar size as a mobile phone. The device comprises the elements that are described next.
2. A touch opaque surface 701 on which the user will act by his/her fingers.
3. The touch surface 701 is divided from a logical point of view in different areas that make up a keyboard 702, and which correspond with the keys in a QWERTY keyboard. Said keyboard 702 is printed on the touch surface 701. Two character sets have been chosen to be placed on the same keyboard, as is customary in many keyboards. One of them is alphanumeric and the other comprises symbols and some multimedia controls. Depending on the status of a control key, one or the other of the character sets will be active.
4. On the upper part of the device 700 there exists a second opaque touch surface 703 that will be used as touchpad. That is to say, the user will be able to move a finger over that surface and as a consequence the mouse cursor will move on the screen of an equipment that is connected to device 400. This touch area is conventional and because of that reason it will not be described in more detail.
5. The device 700 is connected to a computerized system 717 which is connected in turn to a screen 706. Said computerized system can be a general purpose computer, a game console, a media center, a DVD set etc. The connection between the device 700 and the system 717 is performed by radiofrequency, which is a customary connection system for wireless mouses and keyboards. Because this connection system is conventional and well known for the expert in the field, it is not described in detail here.
6. The main components of device 700 are shown in FIG. 8 and are the following ones. The essential component is a detecting grid which is integrated in the device. This grid is the basis of touch surfaces and is used to determine the point in which contact is created with a finger or with an object such as a pointer. There exist several technologies for creating the touch surfaces and the grids, and are well known for the expert in the field, and because of that they will not be discussed here. The device also comprises a microprocessor 802 which is in charge of processing the information that is generated by the grid 801 and interpret the type of contact and the place where it has happened. It also comprises a radiofrequency communications module 803 that will he used to communicate with the computerized system 717. It also comprises a software 804 whose function is integrating the working of the microprocessor 802 and the working of the communications module 803. And it also comprises an electric power system 805, that in this case will be rechargable batteries.
7. In the computerized system 717, an essential component for creating the invention is a software program that performs the following actions: (a) interpreting the signals that come from device 700, (b) showing a keyboard on the screen, (c) showing on said keyboard information regarding the keys that have been pressed, (d) grouping the presses by the user generating a string and (e) take said string to the component 717 that has user focus.
8. Going back to device 700, it contains a touch button 704 that will activate the text mode. When the user presses that button, the device 700 sends an order to the computerized system 701 to show the keyboard 707 on the screen. It is also possible that the keyboard is shown by following the inverse path. When the sure has selected an area for entering text on the screen of system 717, said system 717 will show the keyboard 707.
9. The device 700 also comprises a button 705, whose purpose is to make that the keyboard that is shown in system 717 changes between an alphanumeric keyboard and a keyboard that has control characters, which correspond to the different types of keyboards which are designed over surface 701.
10. The touch surface 701 comprises a keyboard 702 that is printed on it In the preferred embodiment, each key of said keyboard corresponds to two different characters, as has been explained, and as is customary in keyboards. The keys printed on this surface are in correspondence with the keys shown on screen 706.
11. The touch surface 701 is divided in two areas 709 and 710, as shown in the Figure. The device 700 can detect a point of contact in each of the areas. In the preferred embodiment, each one of the areas will detect the position of one of the thumbs 711 and 712 of the user. The screen 706 will show several graphic cursors for helping the user to position his/her fingers and choose the keys. On the one hand, it will show two finger cursors. Also, it will show two key cursors, such as the squares 715 and 716 over the keys that at a given moment are selected by said fingers.

When the user moves the thumbs 711 and 712 in contact over the touch surface, the graphical entities 713 and 714 will move in an equivalent way on the surface 706 following continuous movement. Said graphical entities are transparent, i.e., they allow to see the keys on which they are placed, and their purpose is to send informatics to the user regarding where his/her thumbs are placed in the device 700. Cursors 715 and 716 will also move, but these ones will do it following discrete movement. Both the graphical entities 713 and 714 and the cursors 715 and 716 will be positioned following absolute positioning.

It can be observed that the previous graphical cursors allow that the user simultaneously see the position of the fingers and the key that is active at each moment. (Other types of cursors could be designed. For example, the cursors 713 and 714 could be opaque and the cursors 715 and 716 could be shown over them)

12. For an optimal utilization of the invention, the user will tray to slide his/her thumbs without exerting too much pressure, but without taking them so far as to lose contact. It has already explained earlier that, in this contact, the term “contact” refers to the fact that the thumbs are sufficiently close as for the touch surface to detect them, and that that does not require direct physical contact necessarily.

When the surface loses contact with one of the thumbs, the screen 706 does not show the drawing that corresponds to that thumb, which provides visual information that there is no contact. When this happens, the user loses sensorial information about where he/she has him/her thumb, and will place it again in the position that he wishes. It is easier to use the system if the contact with the thumbs is not lost, because the user will know where they are placed every moment.

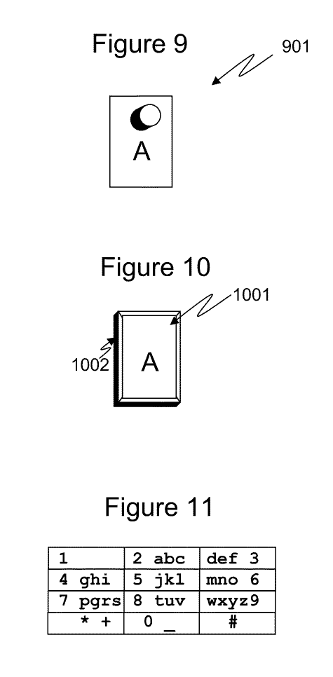

13. As has been said, in the utilization of the invention in the preferred embodiment, the user will be sliding his/her thumbs over the touch screen. When he/she wishes to press a key, he/she will press the finger more firmly, and the device will perceive the increase in pressure, and the increase in contact area, and will interpret that an action on that key has been produced. IN that moment, the computerized system 717 will create a graphical emphasis on the key that has been pressed, which will be based on showing the key with a larger size during a brief time interval.
14. Each one of the areas of the touch screen will have a certain unevenness, such as for example the protuberance 901 that is shown in FIG. 9 for an example area that corresponds to a key. These protuberances will provide tactile information to the user about the area in which he/she is at a given moment. In particular, it will help him/her to perform the right movement of the thumbs over the touch surface. The protuberances must be small enough so that the fingers do not lose contact with the touch surface.

### DESCRIPTION OF OTHER EMBODIMENTS

In other possible embodiment, the keys that have been printed on keyboard 701 are similar to the real keys. That is to say, when they are pressed, they depress, and they also have a protuberant shape. A key of this type is schematically shown in FIG. 10. It can be observed that it has a certain shape 1001 and a cushion 1002 that will yield when there is pressure. The shape 1001 will provide sensorial information to the user regarding where he/she has his/her fingers. The fact that the key yields to the pressure also provides a sensorial sensation similar to the standard physical keyboards. Moreover, when yielding, the finger gets closer to the sensitive grid and becomes easier to detect.

In other possible embodiment the keys that are on the keyboard 401 are real keys. That is to say, not only do they have a shape and yield on the pressure, but also, when the user presses on them, an electrical circuit is closed that makes the system to recognize that that key has been selected. In this embodiment, the touch surface would be used to track the position of the fingers over the keys, but in order to transmit that a key or symbol has been chosen the physical pressure over the real key would be used.

In other possible embodiment, the keyboard is a summary keyboard, similar to the keyboards in many mobile phones, which is schematically represented in FIG. 11. In this embodiment, there can also be a predictive text program, so that the user would not have to press, for example, three times on the key “2” to obtain the letter “c”.

It must be understood that the concrete graphic used for showing the position of the fingers can be different, for example, it can be a normal cross, like those frequently used for showing the position of the pointer of the mouse. It must also be noted that the keyboard 401 might not be divided in more than one area, and that the device could interpret that, if there are two contact points, the left one corresponds to the left finger and the right one correspond to the right finger. Also, the system might detect more man two contact points if it were necessary.

In any of the embodiment there can be additional controls that will implement directional keys, ‘ok’ keys etc.

In any of the previous embodiments, the communications system with the computerized system can be of different types, such as for example a wireless system based on radiofrequency, bluetooth, wifi or infrared, or even a system based on a physical wire.

### Advantages and Inventive Nature of the Invention

Some concrete aspects of the preferred embodiments provide additional advantages over those described in the explanation of the invention. For example, the transparent graphical representations of the fingers will facilitate the user to move with precision without having to switch the sight from the device 700. The cursors 715 and 716 which are shown over the keys will allow him/her at any moment to see exactly what keys are selected.

Also, adding uneven areas or bulges to the touch surface will allow the fingers to move with more agility, because the user has more sensorial information about what position they are in.

1. System for remote controlling computerized systems, comprising a device and a computerized system, wherein:
said device comprises the following means:
means to communicate with said computerized system,
a touch surface, which can be opaque or show a screen,
means to detect the position of an object that the user places close enough to said touch surface, wherein a finger or a pointer are examples of objects,
means to send information to said computerized system about the position of said object,
said computerized system comprises the following means
means to communicate with said device
means for connecting with a screen, with which said system could be optionally integrated
means for showing a keyboard on said screen, wherein one or more of the keys of said keyboard is in correspondence with an area defined on said touch surface
means for showing a cursor over said keyboard on said screen, wherein the position of said object is determined by the position of said object over said touch surface

2. The system in claim 1, wherein said cursor is a complex figure that comprises:
a polygon that is placed over a key, said polygon being positioned with discrete movement,
a figure depicting a finger, which is positioned with continuous movement.

3. The system in claim 1, further comprising:
means for detecting whether the user has chosen an area that is defined on said touch surface,
means for determining the key in said keyboard that corresponds to said area
means for producing a graphical emphasis over said key on said screen
wherein said means are implemented in said device or in said computerized system.

4. The system in claim 1, wherein over said touch surface there exists a graphical representation of said keyboard which shows the position of each key, so that it provides information to the user for positioning said object over the key that the user chooses.

5. The system in claim 1, wherein there exists an uneven area on one or more of said areas defined over said touch surface.

6. The system in claim 5, wherein said uneven areas yield on pressure, as keys in keyboards usually do.

7. The system in claim 5, wherein said uneven areas are keys, and said device comprises:
means for detecting the key that has been pressed, and
means for sending said information to said computerized system

8. The system in claim 1, wherein
said touch surface comprises means for detecting the point of contact of more than one object,
said device comprises means for transmitting the position of more than one said object to said computerized system,
said computerized system shows on said screen as many cursors as objects for which it has received information.

9. The system in claim 1, wherein said touch surface is divided in two parts, so that the left part detects the position of a first object and the right part detects the position of a second object

10. A computerized system that comprises the means of the computerized system in claim 1.

11. A device that comprises the means of the device in claim 1

12. Method for remote controlling computerized systems, comprising the following steps:
providing a device with a touch surface,
providing a computerized system that is connected to a screen,
logically dividing said surface in areas that correspond to a keyboard,
showing a keyboard in said screen whose keys are in correspondence with said areas defined on said surface of said device,
detecting the area in which a user places an object over said touch surface, wherein a finger or a pointer are examples of objects,
sending data about said area to said computerized system,
showing a cursor over said keyboard in a position which is proportional to said area that has been detected.

13. The method in claim 12 wherein said cursor is a complex figure that comprises:
a polygon that is placed over a key, said polygon being positioned with discrete movement,
a figure depicting a finger, which is positioned with continuous movement.

14. The method in claim 12, further comprising:
detecting whether the user has chosen an area that is defined on said touch surface,
determining the key in said keyboard that corresponds to said area
producing a graphical emphasis over said key on said screen
wherein said steps are implemented in said device or in said computerized system.

15. The method in claim 12, wherein over said touch surface there exists a graphical representation of said keyboard which shows the position of each key, so that it provides information to the user for positioning said object over the key that the user chooses.

16. The method in claim 12, wherein there exists an uneven area on one or more of said areas defined over said touch surface.

17. The method in claim 16, wherein said uneven areas yield on pressure, as keys in keyboards usually do.

18. The method in claim 16, wherein said uneven areas are keys, and further comprising the steps of:
detecting the key that has been pressed, and
sending said information to said computerized system

19. The system in claim 12, further comprising the steps of:
detecting the points of contact of more than one object,
transmitting the position of said points of contact to said computerized system,
showing on said screen as many cursors as objects for which it has received information.

20. The method in claim 12, wherein said touch surface is divided in two parts, so that the left part detects the position of a first object and the right part detects the position of a second object
